(19) United States
(12) Patent Application Publication
(10) Pub. No.: US 2010/0282550 A1
(43) Pub. Date: Nov. 11, 2010

(54) MODE ALTERING INSERT FOR VIBRATION REDUCTION IN COMPONENTS

(75) Inventors: James G. Schroth, Troy, MI (US); Mohan Sundar, Troy, MI (US); Shung H. Sung, Troy, MI (US); Michael D. Hanna, West Bloomfield, MI (US); Heewook Lee, Oakland Township, MI (US)

Correspondence Address: General Motors Corporation;c/o REISING ETHINGTON P.C., P.O. BOX 4390, TROY, MI, 48099-4390, US

(73) Assignee: GM GLOBAL TECHNOLOGY OPERATIONS, INC., Detroit, MI (US)

(21) Appl. No.: 12/436,830

(22) Filed: May 7, 2009

(51) Int. Cl. F16D 65/12; F16F 15/00

(52) U.S. Cl. 188/218 XL; 181/208

(57) ABSTRACT

A component with a first number of natural modes of vibration. An insert may be coupled to the component. The insert may have a second number of natural modes of vibration which is a different number than the first number of natural modes of vibration of the component. The insert helps damp vibrations in the component when the component is vibrated.

### TECHNICAL FIELD

The technical field generally relates to products used to damp vibrations in components when the components are vibrated.

### BACKGROUND

Some components are subjected to various vibrations when operated. A component generally has a predefined number of natural modes of vibration based on, among other things, its shape and material properties. The natural modes of vibration may result in the highest amplitude of vibrations in the component with the least input of energy. One or more of the natural modes of vibration may have undesirable effects including, but not limited to, generating noise, having increasing displacement amplitude, or having a prolonged period of vibrations. Inserts may be used to help damp or otherwise dissipate vibrations in components.

### SUMMARY OF EXEMPLARY EMBODIMENTS OF THE INVENTION

One exemplary embodiment includes a product which may include a component that has a first number of natural modes, or patterns, of vibration. The product may also include an insert that may be coupled to the component, and that may have a second number of natural modes, or patterns, of vibration. The second number may be a different number than the first number. The insert may help damp vibrations in the component when the component is vibrated or otherwise oscillated.

One exemplary embodiment includes a product which may include a component and an insert. The component may be manufactured by a casting process. The insert may be coupled to the component. The insert may help damp vibrations in the component when the component is vibrated. The insert may have only a single axis of reflection symmetry about its two-dimensional face of greatest surface area.

One exemplary embodiment includes a product which may include a brake rotor and an insert. The insert may be coupled to the brake rotor. The insert may help damp vibrations in the brake rotor when the brake rotor is vibrated. The insert may have a body and may have a plurality of tabs extending from the body. The plurality of tabs may be spaced irregularly around the body.

One exemplary embodiment includes a method which may include determining a number of natural modes, or patterns, of vibration of a component. The method may also include coupling an insert to the component. The insert may have a number of natural modes, or patterns, of vibration being different than the number of natural modes of vibration of the component. In this way, vibrations in the component may be damped by the insert.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1 is a cross-section of an embodiment of a component having an insert.

FIG. 2 is a perspective view of the insert of FIG. 1, showing various embodiments of the insert.

FIG. 3 is a perspective view of an embodiment of the insert of FIG. 1.

FIG. 4 shows the surface vibration levels at different frequencies generated when a brake rotor is vibrated while having different inserts with different degrees of symmetry.

### DETAILED DESCRIPTION OF EXEMPLARY EMBODIMENTS

The following description of the embodiment(s) is merely exemplary (illustrative) in nature and is in no way intended to limit the invention, its application, or uses.

The figures illustrate various embodiments of an insert 10 that may be used in a component, such as but not limited to an automotive component, in order to help damp or otherwise dissipate vibrations or other oscillations in the component. In certain embodiments, this may help suppress, or reduce the intensity of, sound and noise that can be emitted by the component when the component is vibrated at certain frequencies. In some embodiments, the insert 10 may be designed, arranged, or designed and arranged, to target and damp specific natural modes of vibration for a particular component. The targeted natural modes of vibration may emit more undesirable noise as compared to other natural modes of vibration that are not targeted in the particular component. In some components, the specific natural modes of vibration may be targeted while keeping the originally intended design and arrangement of the component. In other words, the component itself (e.g., external boundaries, shape, and the like) need not necessarily be modified in order to help damp undesirable natural modes of vibrations.

The automotive component may be any component in an automobile that may be subjected to vibrations such as but not limited to a brake rotor 12, a brake drum, an electric motor, a transmission housing, a gear housing, an exhaust manifold, a cylinder head, a bracket, or the like. Other components may include nonautomotive applications including, but not limited to, sporting equipment, housing appliances, manufacturing equipment such as lathes, milling/grinding/drilling machines, or other components subjected to vibrations. Some of these components may be manufactured by a variety of processes including casting, machining, or any other suitable process. In the example shown, the brake rotor 12 may be subjected to vibrations when a pair of brake pads (not shown) is forced against the brake rotor by a caliper in order to generate friction that slows the associated automobile.

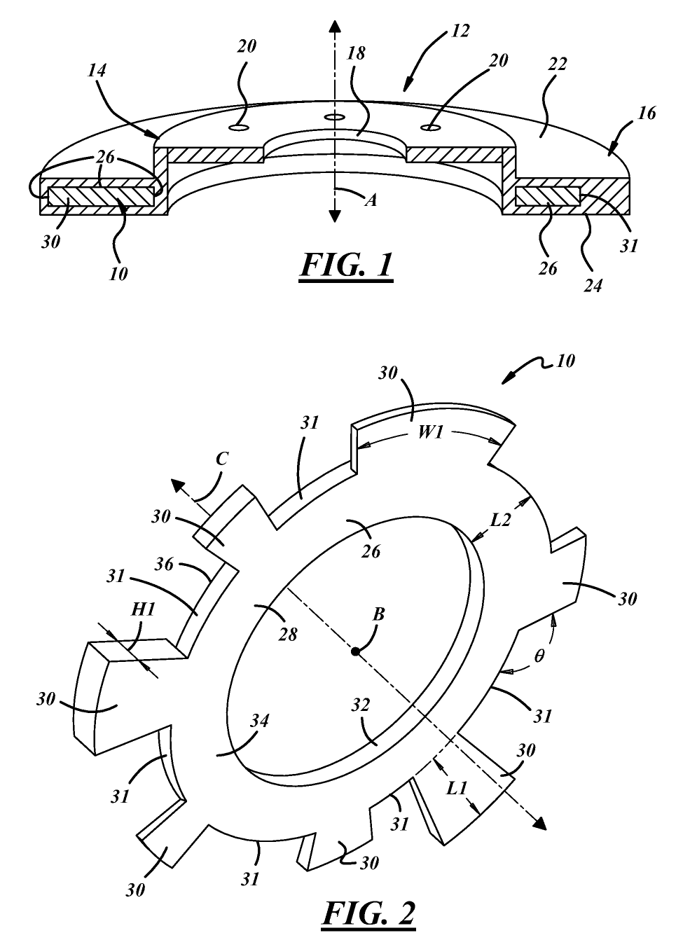

Referring to FIG. 1, the brake rotor 12 may be of the solid-type as shown, may be of the vented-type (not shown) having a plurality of vanes, or may be of another type. The brake rotor 12 may include a hub portion 14 and a cheek portion 16 extending from the hub portion. The hub portion 14 may define a central aperture 18 about a central axis A, and may also define a plurality of bolt holes 20. The cheek portion 16 may include a first cheek face 22 and an opposite second cheek face 24 that each, or together, constitute braking surfaces of the brake rotor 12. In one exemplary embodiment, the brake rotor 12 may be made by a casting process to form a one-piece structure. In select exemplary embodiments, the brake rotor 12 may include iron, titanium, steel, aluminum, magnesium, or any of a variety of other alloys or metal matrix composites. As will be appreciated by skilled artisans, the exact casting process used to form the brake rotor 12, including the number of steps, the order of the steps, the parameters within each step, and the like, may vary among different brake rotors and among different components. For instance, the casting process may be a vertical or a horizontal casting process, and may be a sand casting process.

As mentioned, the insert 10 may be designed, arranged, or both designed and arranged, to target and damp specific undesirable natural modes of vibration in the brake rotor 12. In some cases (but not all), sound may be associated with unwanted vibrations. The insert 10 may help suppress, or reduce the intensity of, sound and noise (e.g., ringing) at the targeted natural modes of vibration. For example, when the brake rotor 12 is vibrated, relative sliding, movement, and other contact at an interface boundary formed between an outer surface 26 of the insert 10 and an opposing surface of the brake rotor absorbs energy of vibrations, through friction to consequently damp the vibrations; but this way of damping vibrations need not necessarily be present. If present, the interface boundary may be formed along a surface of the cheek portion 16 (or the product body) and the outer surface 26 of the insert 10 (e.g., mechanically distinguishable surfaces) such that relative movement at the interface boundary generates friction and dissipates energy so as to reduce vibrations. In the case where the insert 10 is a solid matter, the friction generated by the relative sliding, movement, and other contact between the insert and the brake rotor 12 may help dissipate energy. In one embodiment, the interface boundary may have a length of at least 1 mm.

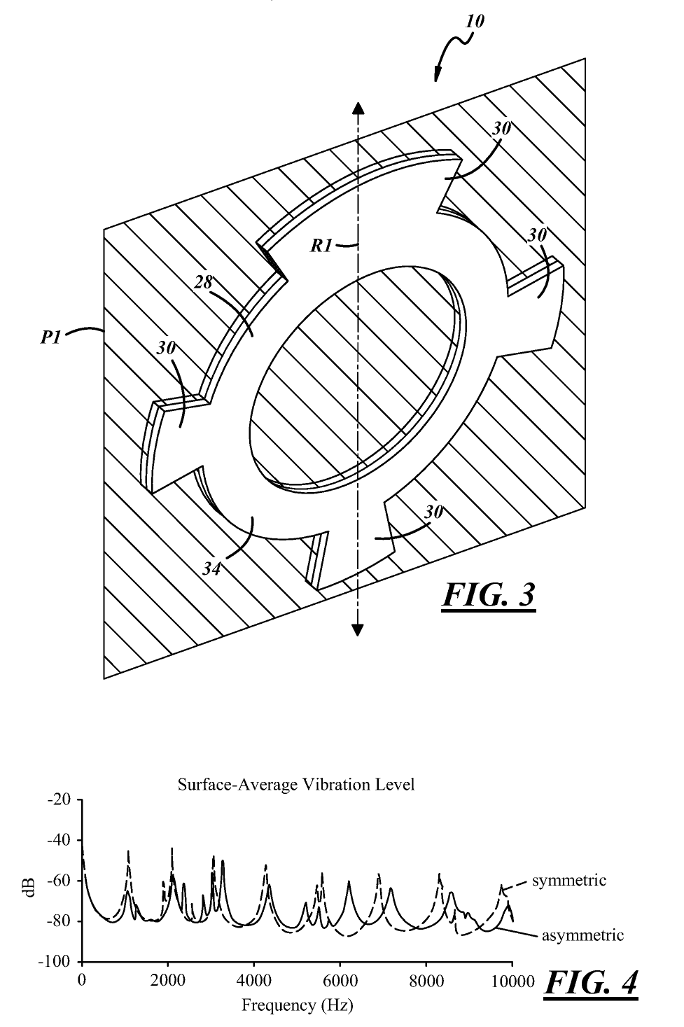

In the example of FIGS. 2 and 3, the insert 10 may have a body 28 and may, though need not have a plurality of tabs 30 extending from the body. The tabs 30 may be used in a manufacturing process, and may extend inwardly toward a central axis C as opposed to outwardly as shown, and may have different shapes other than those shown. A plurality of recesses 31 may be defined between each pair of tabs 30. The insert 10 may be shaped complementary to the particular component in which it is used, in this case the brake rotor 12. The body 28 may define a central aperture 32 about a center point B, and may have a first face 34 and an opposing second face 36. The first and second faces 34 and 36 may have the greatest surface area of the exposed surfaces of the insert 10 in contact with the brake rotor 12 (or other component) as can be observed from FIG. 2. The insert 10 may include a metal such as, but not limited to, aluminum, steel, stainless steel, cast iron, and any of a variety of other alloys, or metal matrix composites including abrasive particles. The metal of the insert 10 may have a higher melting point than the melting point of the molten material being cast around at least a portion of the insert so that the insert would not melt during the casting process, if a casting process is used. In one embodiment, there may be multiple inserts 10 placed in the brake rotor 12 or other component at different locations. And in one example, the insert 10 may have a thickness of 2 mm; other thicknesses are possible.

The exact structure, placement, and coupling of the insert 10 in the component may be dictated by, among other things, the particular natural modes of vibration that are being targeted for damping in the component; in some cases, the exact structure, placement, and coupling may be limited by a potential mass imbalance created by the insert in the particular product. For example, referring to FIG. 2, there may be any number of the plurality of tabs 30, and the tabs may be irregularly spaced around the body 28 defining unequal recesses 31 between each pair. Also, one or more of the plurality of tabs 30 may have different dimensions with respect to the other tabs. For example, a tab 30 may have a different width W1 as compared to the other tabs, a tab may have a different length L1 as compared to the other tabs, a tab may have a different height H1 as compared to the other tabs, and a tab may have a side that forms a different angle θ with respect to the body 28 as compared to other sides of other tabs (e.g., side need not be oriented radially through the center point B). As another example, the body 28 may have a different length L2 as measured between a neighboring pair of tabs 30 as compared to the length of the body measured between another neighboring pair of tabs.

Depending on the insert's exact structure, portions of the insert 10 may have defined relationships. In the example of FIG. 3 with one tab 30 different than the others, the first face 34 may be symmetrical in two-dimensions about a single reference axis of reflection symmetry R1. This means that if the first face 34 is folded along the axis of reflection symmetry R1, the two halves would be shaped identically (i.e., be mirror images of each other); and in this example, this is only true when folded along the single axis of reflection symmetry R1 and along no other axis. In the example of FIG. 2 with irregularly spaced or shaped tabs, the first face 34 may not be symmetrical about any axis of reflection. That is, the first face 34 may be asymmetrical or nonuniform. Back to the example of FIG. 3, the insert 10 may be symmetrical in three-dimensions about a single reference plane of reflection symmetry P1. This means that if the insert 10 is cut along the plane of reflection symmetry P1, the two halves would be shaped identically and would have the same volumes. In another example, the insert 10 may not be symmetrical about any plane of reflection. That is, the insert 10 may be slightly asymmetrical or nonuniform. This is true when, for example, the height H1 is different for one tab as compared to other tabs, as shown in FIG. 2. In another example, a first pair of tabs 30 may be positioned opposite each other (180° apart) and may be identically shaped with respect to each other (e.g., trapezoidal shape). A second pair of tabs 30 may be positioned opposite each other (180° apart) and may be identically shaped with respect to each other (e.g., rectangular shape). The second pair of tabs 30 may be positioned at an angle other than 90° with respect to the first pair of tabs 30.

The insert 10 may be positioned within or coupled to the brake rotor 12 to target particular natural modes of vibration of the brake rotor 12 for damping vibrations. For example, when assembled, the central axis C of the insert 10 may be offset with the central axis A of the brake rotor 12 such that the insert and the brake rotor are slightly off-center with respect to each other and are eccentric. In another example, the insert 10 may be composed of a material having a different density than that of the material of the brake rotor 12 in order to target particular natural modes of vibration of the brake rotor for damping. And in another example, the insert 10 may be composed of a material having one or more values of elastic moduli (e.g. Young's Modulus (E)) that are different than those of the material of the brake rotor 12 in order to target particular natural modes of vibration of the brake rotor for damping. In yet another example, the insert 10 may initially be coated with a material (subsequently described) that facilitates formations of the interface boundary once the insert if located in the brake rotor 12. In one example, the coating may form a discontinuous interface boundary that may contribute to vibration damping in at least the way described in the immediate subsequent paragraph.

Each of the above examples of inserts, or an insert with a combination thereof, may exhibit different damping qualities when used in the brake rotor 12. In some examples, the insert 10 may have a first number of natural modes of vibration, while the brake rotor 12 (excluding the presence of the insert) has a second number of natural modes of vibration that is different than the first number. When combined, the rotor-with-insert body has a different vibrational response than the brake rotor alone and than the insert alone. Different numbers of natural modes of vibration among the insert 10 and the brake rotor 12 may help damp vibrations in the brake rotor, and may help target a particular natural mode of vibration for damping, though no targeting is needed. This type of vibration damping may be independent of the vibration damping caused by friction; indeed, in some cases, the latter type may not be present while the former type is present.

When the brake rotor 12 with the insert 10 is vibrated, the first number of natural modes of vibration and the second number of natural modes of vibration alter or interfere with each other to consequently damp vibrations that may otherwise be caused by the first number of natural modes of vibration. For example, the mode altering may result in a reduced amplitude of vibration for the particular targeted frequencies. In a similar way, the interface boundary may have a third number of natural modes of vibration that may alter or interfere with the first number of natural modes of vibration, the second number of natural modes of vibration, or both, to consequently damp vibrations. The interface boundary may also interfere with the movement of respective vibrations between the insert 10 and the brake rotor 12; this interference may consequently damp vibrations.

FIG. 4 is a graph showing the damping qualities of an example insert that is slightly asymmetrical (solid line and simulated via finite element analysis), versus an example insert that is nominally symmetrical (phantom line and resulting from experiments) about more than one axes of reflection. The insert that is nominally symmetrical had six-fold planar symmetry. As can be observed, the asymmetrical insert may emit lower surface vibration levels at certain frequencies as compared to the symmetrical insert. It should be noted that the results of FIG. 4 were generated by a finite element model and by experiments with hardware, and that all simulations and experiments may not yield this exact data.

Various methods may be used to place or couple the insert 10 to the component, such as but not limited to, the brake rotor 12. In one example, the insert 10 may be cast-in-place to be completely within and completely bounded by the cheek portion 16 of the brake rotor 12. Such cast-in-place processes may be performed by using locating pins, clamps, magnets, and the like to suspend the insert 10 in a molding machine cavity while molten material floods the cavity and eventually solidifies. In another example which may depend on the shape and size of the insert 10, a cavity or slot may be cut or otherwise machined in the cheek portion 16 in order to carry the insert therein. The insert 10 may then be put into the space defined by the cavity. An open end of the cavity may, though need not, be closed and sealed to enclose the insert 10. One way of closing and sealing the open end may be to place a wire such as a copper wire, a solder, or other suitable fusible material to fill the open end and close it off by subsequent fusing. In another example method of placing the insert 10 in the brake rotor 12, a first and second portion of the brake rotor (e.g., a plane cutting the cheek portion in half) may each be cast as a separate component. The first and second portions may each define cavities with open ends that are complementary in shape and size. The insert 10 may be placed between the cavities, and then the first and second portions may be joined and sealed by welding at an interface thereof when the portions are brought together. In another example method, a sacrificial insert may be used to form a slot or cavity to place the insert 10 in. The sacrificial insert would be composed of a material that could withstand (i.e., not melt at) the temperature of the molten material of the brake rotor 12 during casting. After solidification, the sacrificial insert could be removed, for example, by etching or machining, thus leaving a cavity that the insert 10 could be placed in.

Another exemplary embodiment includes a method which may include determining the number of natural modes of vibration of a component, such as the example components mentioned above like the brake rotor 12, that is subject to vibrations during use. The method may also include selecting, designing, and/or coupling the insert 10 to the component. The insert 10 may have a number of natural modes of vibration that is different than the number of natural modes of vibration of the component so that vibrations in the component are damped by the insert when the component is vibrated.

In some embodiments, the outer surface 26 of the insert 10 may be bonded to the particular component in which the insert is used with or to the example cheek portion 16, or may be free to move. The bonding may be accomplished by, for example, metal casting, welding, adhesive bonding, or other suitable processes. Whether bonded or free to move, the insert 10 may be located completely within and bounded by the particular component, such as is shown in the example brake rotor 12 of FIG. 1. In other embodiments, the insert 10 may be only partially located within the component while still damping vibrations. That is, the outer surface 26 may be partly exposed and may be flush with an outer surface of the component, where the insert 10 would constitute an inlay.

In the example shown, the outer surface 26 or the opposing inner surface of the brake rotor 12 may be coated to form a layer that facilitates energy absorption and thus helps damp vibrations. Suitable coatings may include a plurality of particles which may be bonded to each other and/or to the particular surface by an inorganic binder, an organic binder, or another suitable bonding material. Suitable binders may include epoxy resins, phosphoric acid binding agents, calcium aluminates, sodium silicates, wood flour, or clays. In one embodiment, the coating may be deposited on the particular surface as a liquid dispersed mixture of alumina-silicate-based, organically bonded refractory mix. In other embodiments, the coating may include at least one of alumina or silica particles, mixed with a lignosulfonate binder, cristobalite (SiO₂), quartz, or calcium lignosulfonate. The calcium lignosulfonate may serve as a binder. In one embodiment, the coating may include any types of coating used in coating casting ladles or vessels, such as IronKote or Ladlekote type coatings. In one embodiment, a liquid coating may be deposited on a portion of the particular surface, and may include high temperature Ladlekote 310B. In another embodiment, the coating may include at least one of clay, Al₂O₃, SiO₂, a graphite and clay mixture, silicon carbide, silicon nitride, cordierite (magnesium-iron-aluminum silicate), mullite (aluminum silicate), zirconia (zirconium oxide), or phyllosilicates. In one embodiment, the coating may comprise a fiber such as ceramic or mineral fibers.

Interface boundaries that may absorb energy and thus help damp vibrations may be formed with the coatings and may include, but are not limited to: the inner surface of the brake rotor 12 against the layer formed, the outer surface 26 against the layer, the inner surface of the brake rotor 12 against the particles or fibers, the outer surface 26 against the particles or fibers, and movement of the particles or fibers against each other.

The exact thickness of the coating may vary and may be dictated by, among other things, the materials used for the insert 10 and the brake rotor 12, and the desired degree of vibration damping. Examples of thicknesses may range from about 1 μm-400 μm, 10 μm-400 μm, 30 μm-300 μm, 30 μm-40 μm, 40 μm-100 μm, 100 μm-120 μm, 120 μm-200 μm, 200 μm-300 μm, 200 μm-550 μm, or variations of these ranges.

Some examples of suitable particles or fibers that may be a part of a particular coating may include, but is not limited to, silica, alumina, graphite with clay, silicon carbide, silicon nitride, cordierite (magnesium-iron-aluminum silicate), mullite (aluminum silicate), zirconia (zirconium oxide), phyllosilicates, or other high-temperature-resistant particles. In one example, the particles may have a length as defined by the longest dimension in a range of about 1 μm-350 μm, or 10 μm-250 μm.

In an embodiment having a coating with particles, fibers, or both, the particles may have an irregular shape (e.g., not smooth) to augment vibration damping. The particles, fibers, or both, may be bonded to each other or to the outer surface 26, the inner surface of the brake rotor 12, or to both because of, among other things, the inherent bonding properties of the particles or fibers. For example, the bonding properties of the particles or fibers may be such that the particles or fibers may bind to each other or to the outer surface 26, to the inner surface of the brake rotor 12, or to both under compression. In an example, the particles, fibers, or both, may be treated to provide a coating on the particles or fibers themselves, or to provide functional groups attached thereto to bind the particles together or attach the particles to at least one of the outer surface 26 or the inner surface of the brake rotor 12. In another example, the particles, fibers, or both may be embedded in at least one of the outer surface 26 or the inner surface of the brake rotor 12 to augment vibration damping.

In another embodiment, the particles, the fibers, or both, may be temporarily held together, held to the outer surface 26, or held to both, by a fully or partially sacrificial coating. The sacrificial coating may be consumed by molten metal or burnt off when metal is cast around or over the insert 10. The particles, fibers, or both are left behind and trapped between the brake rotor 12 and the insert 10 to provide a layer consisting of the particles, the fibers, or both.

In another embodiment, one or more of the outer surface 26 and the inner surface of the brake rotor 12 may include a relatively rough surface including a plurality of peaks and valleys to enhance the frictional damping of the part. In this example, the outer surface 26, the inner surface of the brake rotor 12, or both, may be abraded by sandblasting, glass bead blasting, water jet blasting, chemical etching, machining, or any other suitable process that may produce relatively rough surfaces.

In an embodiment where the brake rotor 12 is cast over the insert 10 and the particles, fibers, or both may be exposed to the temperature of a molten material, the insert 10, the particles, the fibers, or all, may be made from materials that can resist flow and significant erosion during the casting process. For example, the insert 10, the particles, the fibers, or all, may be composed of refractory materials that can resist flow and erosion at temperatures above 1100° F., above 2400° F., or above 2700° F. In an example casting process, when molten material is poured, the insert 10, the particles, the fibers, or all, should not be wet by the molten material so that the molten material does not bond where an interface boundary would otherwise be formed. Relative movement of the particles, insert, or surfaces of the product body may cause friction and dissipation of vibrations.

In an embodiment where the brake rotor 12 is made using a process that subjects the insert 10, the particles, the fibers, or all, to relatively high temperatures associated with molten materials, the insert 10, the particles, the fibers, or all, may be made from a variety of materials including, but not limited to, non-refractory polymeric materials, ceramics, composites, wood, or other materials suitable for frictional damping. For example, such non-refractory materials may also be used (in addition to, or as a substitute for refractory materials) when two portions of the brake rotor 12 are held together mechanically by a locking mechanism, by fasteners, by adhesives, or by welding.

In another embodiment, a wettable surface may be provided that does not include a layer with particles or fibers, or a wettable material such as graphite is provided over a section of the insert 10, so that the cast metal is bonded to the wettable surface in order to attach the insert to the brake rotor 12 while still permitting frictional damping on the non-bonded surfaces.

The above description of embodiments of the invention is merely exemplary in nature and, thus, variations thereof are not to be regarded as a departure from the spirit and scope of the invention.

What is claimed is:

1. A product comprising:
a component having a first number of natural modes of vibrations; and
an insert coupled to the component, the insert having a second number of natural modes of vibration which is different than the first number of natural modes of vibration in order to damp vibrations in the component when the component is vibrated.

2. A product as set forth in claim 1 wherein the component comprises a casting process.

3. A product as set forth in claim 1 wherein the insert has only a single axis of reflection symmetry about its two-dimensional face of greatest surface area.

4. A product as set forth in claim 1 wherein the insert does not have a single axis of reflection symmetry about its two-dimensional face of greatest surface area.

5. A product as set forth in claim 1 wherein the insert has a body and a plurality of tabs extending from the body.

6. A product as set forth in claim 5 wherein the plurality of tabs are spaced irregularly around the body.

7. A product as set forth in claim 5 wherein at least one of the plurality of tabs has different dimensions than the other of the plurality of tabs.

8. A product as set forth in claim 5 wherein the length of the body is different as measured between one pair of neighboring tabs with respect to the length of the body measured between another pair of neighboring tabs.

9. A product comprising:
a component that is manufactured by a casting process; and
an insert coupled to the component in order to damp vibrations in the component when the component is vibrated, the insert having only a single axis of reflection symmetry about its two-dimensional face of greatest surface area.

10. A product as set forth in claim 9 wherein the component has a first number of natural modes of vibration, and the insert has a second number of natural modes of vibration, the first number being different than the second number.

11. A product as set forth in claim 9 wherein the component is a brake rotor, and the insert has a body and a plurality of tabs extending from the body.

12. A product as set forth in claim 11 wherein the plurality of tabs are spaced irregularly around the body.

13. A product as set forth in claim 11 wherein at least one of the plurality of tabs has different dimensions than the other of the plurality of tabs.

14. A product as set forth in claim 11 wherein the length of the body is different when measured between one pair of neighboring tabs with respect to the length of the body measured between another pair of neighboring tabs.

15. A product comprising:
a brake rotor;
an insert coupled to the brake rotor in order to damp vibrations in the brake rotor when the brake rotor is vibrated, the insert having a body and a plurality of tabs extending from the body, wherein the plurality of tabs are spaced irregularly around the body.

16. A product as set forth in claim 15 wherein at least one of the plurality of tabs has different dimensions than the other of the plurality of tabs.

17. A product as set forth in claim 15 wherein the insert is located off-center with respect to the component.

18. A product as set forth in claim 15 wherein the length of the body is different as measured between a pair of neighboring tabs with respect to the length of the body measured between another pair of neighboring tabs.

19. A product as set forth in claim 15 wherein the brake rotor has a first number of natural modes of vibration, and the insert has a second number of natural modes of vibration, the first number being different than the second number.

20. A method comprising:
determining the number of natural modes of vibration of a component;
coupling an insert to the component, the insert having a number of natural modes of vibration different from the number of natural modes of vibration of the component so that vibrations in the component are damped by the insert.
